(19) United States
(12) Patent Application Publication
(10) Pub. No.: US 2013/0046648 A1
(43) Pub. Date: Feb. 21, 2013

(54) SHOPPING LIST SYSTEM AND PROCESS

(71) Applicants: Matthew A. Calman, Charlotte, NC (US); Susan Smith Thomas, Gastonia, NC (US); Carrie Anne Hanson, Charlotte, NC (US); Alicia C. Jones, Fort Mill, SC (US); Erik Stephen Ross, Charlotte, NC (US)

(72) Inventors: Matthew A. Calman, Charlotte, NC (US); Susan Smith Thomas, Gastonia, NC (US); Carrie Anne Hanson, Charlotte, NC (US); Alicia C. Jones, Fort Mill, SC (US); Erik Stephen Ross, Charlotte, NC (US)

(73) Assignee: Bank of America Corporation, Charlotte, NC (US)

(21) Appl. No.: 13/212,094

(22) Filed: Aug. 17, 2011

(51) Int. Cl. G06Q 30/00

(52) U.S. Cl. 705/26.3

(57) ABSTRACT

Embodiments of the invention allow a user to create a virtual shopping list that is used to identify offers for products in which the user is interested. The shopping list may be one single list or may be broken down into categories, in order to group like products together or group products together that can be purchased at one or more locations near each other. The shopping list may be transmitted to one or more businesses, such that the businesses may submit bid requests, in a reverse bid auction, for the one or more products on the shopping list. The best bids of the one or more businesses may be returned to the user. The bids may be identified as the best bids based on the lowest prices for the product, the best quality products, the proper quantities of the products, the locations at which the products are located, etc.

### BACKGROUND

Customers are interested in identifying the best deals on goods and services (hereinafter “products”), while businesses are constantly trying to connect with new customers to grow market share and revenues. It is often difficult for customers that have decided to purchase a product to identify the businesses that offer the product at the best price, the product that has the best quality, the right quantity of the products, and/or the most convenient location to get the product. These issues are arise, in part, because of the fact that there are an abundance of options in the market for the same or similar products, and details associated with the products are changing often. There is a need to develop systems and processes that allow a customer to identify the products in which the customer is interested, while at the same time allowing businesses to interact with customers to provide the products.

### SUMMARY

The following presents a simplified summary of one or more embodiments of the invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Generally, methods, apparatus systems and computer program products are described herein that allow a user to create a virtual shopping list (“shopping list”). The user may utilize one or more data capture devices (i.e. camera, scanner, optical reader, keypad, microphone, etc.) to capture information about products through a product identifier (i.e. object in an image, 3D/2D barcodes, identification numbers, product codes, product names, brand names, etc.) and add them to a virtual shopping list. The shopping list may be one single list or may be broken down into categories, defined by the user or business, in order to group like products together or group products together that can be purchased at one or more locations near each other.

The system in some embodiments may transmit the shopping list of one or more users to businesses, such that the businesses may submit bid requests, in a reverse bid auction, for the one or more products on the shopping list. The best bids of the one or more businesses may be returned to the user. The bids may be identified as the best bids based on the lowest prices for the product, the best quality products, the proper quantities of the products, the locations at which the products are located, etc.

In another embodiment, the system may access the prices of products for different businesses and provide the user with recommendations for purchasing the products on the user's shopping list based on the best prices, best quality, best quantity, best location (i.e. most convenient location), etc. available to the user. The prices and locations of the products on the virtual shopping list may be accessed through online databases of various businesses over the internet, through specialized databases that the businesses allow the shopping systems to access, through shared databases, on the shopping systems that may be accessed by the business systems, etc. The system may provide the user with the pricing for all of the products from each of the business, the quantity of the products each business has, the best locations of the businesses that sell the products, a bi-furcated list of the one or more stores from which to buy the one or more products in order to receive the best offers, etc.

In some embodiments of the invention the offers provided by the system through the bid process or offer determination process may be discounted based on the user's behavior. For example, a business may offer discounts to a user on products in return for the user making all the purchases at a particular store. In other examples a business may match the prices of other businesses making the same or similar offers. Still in other examples, a business may offer discounts based on users reward programs, group discounts, negotiating between the parties, etc. In some cases the discounts may be based on a user's transaction history (i.e. products that the user purchased in the past, shopping habits, etc.) or customer profile information (i.e. demographic information, geographic information, requested offers, etc.). These are only a few of the potential ways that discounts could be offered to the users through the use of the shopping lists.

In other embodiments of the invention, a user may utilize offers provided by businesses (i.e., through shopping lists, direct offers, marketing programs, group offers, etc.) to optimize travel routes for purchasing the products in which the user is interested. In some embodiments the system may provide the user with a route (i.e. directions, map, etc.) that directs the user to the optimized route for purchasing a first product, a second product, a third product, etc. In some embodiments the route may be based on the user's home location, work location, current location, past location, future location, specified address, etc. In some embodiments of the invention the shopping list may be utilized in combination with a mobile device with a location determining device (i.e. positioning device, navigation device, Global Positioning Satellite “GPS,” accelerometer, etc.) to optimize a route to businesses for purchasing products based a location of the user (i.e. the position of the mobile device, selected location in the future, or past location of the user), and the products on the shopping list. Therefore, the offers may be based on the user's current location, past location, future location, a specified location, and/or multiple current, past, or future locations (hereinafter “locations”). For example, a user desires food for dinner as well as a household good to purchase during a trip. The mobile device optimizes the user's route based on the best offers received from businesses, a location determined by the user, and businesses proximate to the location. In some embodiments, optimization of the route may take into account economic impacts (i.e. gas prices), environmental impacts (i.e. weather), the time a user spends in a location, discounts provided by the businesses, etc., in addition to offers received from the businesses. In some embodiments of the invention the optimized route may be split between two or more people, over one or more trips, that may occur over one or more days, in order to maximize the best offers that can be received by a user with minimal expenditures of time, money, etc.

In some embodiments of the invention, the user may add products to the virtual shopping list through real-time object recognition analysis of product identifiers, such as but not limited to logos, artwork, products, locations, buildings, writing, barcodes, UPC, RF identification tags, people and other features that can be captured by a data capture device. Capturing product identifiers may be done through a number of different data captures devices, as explained in further detail later. However, in one embodiment product identifiers may be captured in an augmented reality (“AR”) environment utilizing a video stream (or image) and a system that matches product identifiers in the video (or image) to data associated with the products. Data associated with the product identifiers may include product information, pricing information, location information, quantity information, etc. about the same or similar products as the products captured by the data capture device. Therefore, after identifying the product, the user may choose to whether or not to add the product to the user's shopping list.

Embodiments of the invention comprise methods, systems, and computer program products for utilizing a shopping list to receive offers for products in which a user is interested. The invention comprises identifying products on a virtual shopping list of a user; subjecting the virtual shopping list to a bid auction for two or more businesses; identifying one or more offers for one or more products from the one or more businesses based on the virtual shopping list of the user; making the one or more offers identified from the one or more businesses available to the user; identifying a selection of the one or more offers from the user; and making the selection of the one or more offers available to the one or more businesses.

In another embodiment, the invention further comprises receiving a request from the user to add products to a virtual shopping list. In further accord with an embodiment of the invention, the products added to the virtual shopping list were captured by the user utilizing a data capture device that captures product identifiers.

In yet another embodiment of the invention, subjecting the virtual shopping list to a bid auction comprises transmitting the virtual shopping list to one or more businesses. In still another embodiment of the invention, subjecting the virtual shopping list to a bid auction comprises allowing the one or more businesses to access the virtual shopping list.

In further accord with an embodiment of the invention, the one or more offers are for all of the products on the virtual shopping list. In another embodiment of the invention, the selection of the one or more offers is for all of the products on the virtual shopping list. In still another embodiment of the invention, the selection of the one or more offers is from one of the one or more businesses. In yet another embodiment of the invention, the selection of the one or more offers is from two or more of the businesses.

In another embodiment, the invention further comprises identifying a discount from the one or more businesses associated with the one or more offers.

In still another embodiment, the invention further comprises identifying a location associated with the user; and wherein the offers received for the one or more products from the one or more businesses are based on the location.

To the accomplishment the foregoing and the related ends, the one or more embodiments comprise the features hereinafter fully described and particularly pointed out in the claims. The following description and the annexed drawings set forth detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a high level process flow illustrating a shopping list offer process, in accordance with one embodiment of the invention;

FIG. 2 is a block diagram illustrating a shopping system environment, in accordance with an embodiment of the invention

FIG. 3 is a block diagram illustrating a shopping system environment, in accordance with an embodiment of the invention;

FIG. 4 is a block diagram illustrating a mobile device, in accordance with one embodiment of the invention;

FIG. 5 is a process flow illustrating a shopping list bid process, in accordance with an embodiment of the invention;

FIG. 6 is a process flow illustrating a shopping list offer determination process, in accordance with an embodiment of the invention; and

FIG. 7 is a process flow illustrating an optimized offer routing process, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident, however, that such embodiment(s) may be practiced without these specific details. Like numbers refer to like elements throughout.

The embodiments described herein may refer to providing an offer for a transaction or transaction event that is based in part on a location of the user and/or the user's mobile device 100. In various embodiments, occurrence of a transaction also triggers the sending of additional information such as product offers and the like. Unless specifically limited by the context, a “transaction” refers to any communication between the user and the financial institution or other entity monitoring the user's activities. In some embodiments, for example, a transaction may refer to a purchase of products, a return of products, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of products, an account balance inquiry, a rewards transfer, an account money transfer, opening a bank application on the user systems 20 (i.e. mobile device 100), a user accessing their e-wallet or any other interaction involving the user and/or the user systems 20 that is detectable by the financial institution. As further examples, a transaction may occur when an entity associated with the user is alerted via the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing products (e.g., groceries, stamps, tickets, DVDs, vending machine items, TV's, construction services, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by user systems 20, such as a user's mobile device 100. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the business's perspective or both. In some embodiments, the point-of-transaction device refers only to the shopping systems 10, the user systems 20, or business systems 30, in other embodiments it refers to two or more of the shopping systems 10, user systems 20, and business systems 30 interacting to perform a transaction. For example, in one embodiment, the point-of-transaction device refers to the user's mobile device 100 configured to communicate with a business's point of sale terminal, whereas in other embodiments, the point-of-transaction device refers to the business's point of sale terminal configured to communicate with a user's mobile device 100, and in yet other embodiments, the point-of-transaction device refers to both the user's mobile device 100 and the business's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

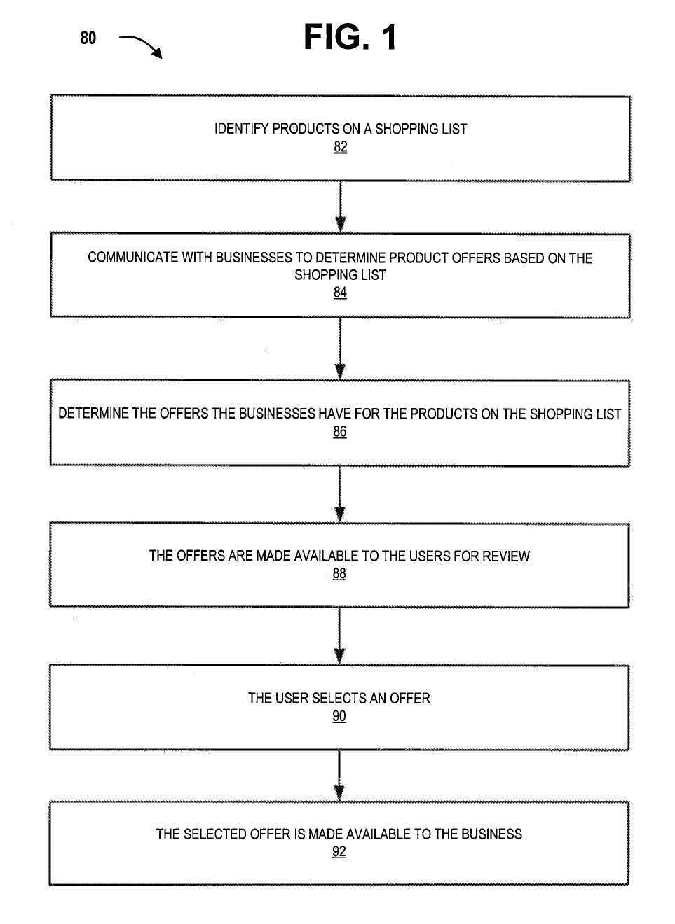

FIG. 1 illustrates a high level process flow for a shopping list offer process 80, in accordance with one embodiment of the present invention. As illustrated by block 82, product(s) on a shopping list are identified by a system. The system communicates with business systems to determine product offer(s) based on the product(s) on the shopping list, as illustrated by block 84 in FIG. 1. As illustrated by block 86, the system determines the offer(s) the businesses have for the product(s) on the shopping list. As illustrated by block 88, the product offer(s) are made available to the user for review. The system may receive a selection from a user accepting the available offer(s), as illustrated by block 90. As illustrated by block 92 in FIG. 1, the system makes the selected offer(s) available to the businesses so the transaction for the product(s) may be completed.

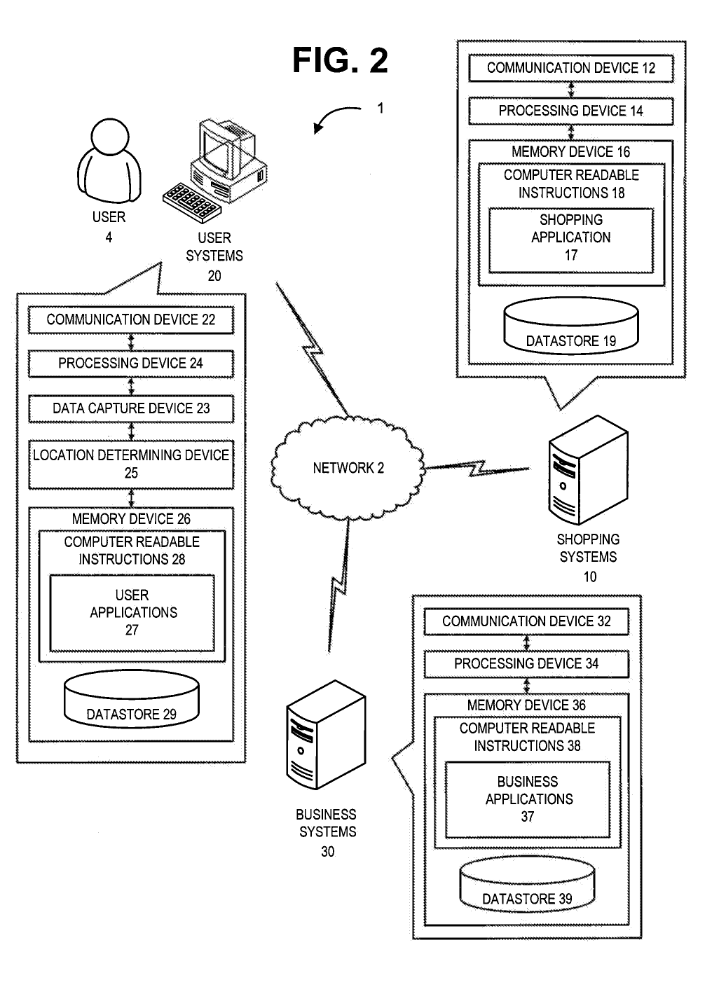

FIG. 2 illustrates a shopping system environment 1, in accordance with an embodiment of the present invention. As illustrated in FIG. 2, the shopping systems 10 are operatively coupled, via a network 2 to user computer systems 20, and business systems 30. In this way a shopping system environment 1 may be set up to allow a user 4 to create a shopping list of products, which can be utilized to identify the best available offers from various businesses (i.e. business one 62, business two 64, business three 66). In the present invention, the businesses may bid on one or more products on the shopping list, or the entire shopping list. In other embodiments the systems may access public information to find the best offers from various businesses. In still other embodiments of the invention the systems may access private information from the businesses to find the best offers from the various businesses. In still further embodiments, the businesses may upload product offer data to the systems in order to allow systems to determine the available offers. The offers made available to the users 4 may only be the best available offers for the products, which may be the best offers in terms of pricing, location, quality, quantity, etc. In some embodiments the offers made available may be all of the offers identified by the systems. Thereafter, the user may finalize the transactions (i.e. purchases, leases, etc.) for the offers directly through the businesses, or indirectly through the shopping systems 10 or other systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 2, the shopping system 10 comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the user computer systems 20, and one or more business systems 10. As such, the communication device 12 generally comprises a modem, server, or other device for communicating with other devices on the network 2.

As further illustrated in FIG. 2, the shopping systems 10 comprise computer-readable instructions 18 stored in the memory device 16, which in one embodiment includes the computer-readable instructions 18 of a shopping application 17. In some embodiments, the memory device 16 includes a datastore 19 for storing data related to the shopping systems 10, including but not limited to data created and/or used by the shopping application 17.

The shopping application 17 is an application that is used to receive, process, store, and send information relating to products in which a user 4 may be interested (i.e., a shopping list, products being viewed on the internet, products based on customer transaction history and/or demographic information, etc.) and product offers provided by businesses. The shopping application 17 may access or be accessed by the user systems 20 in order to identify the products in which the user is interested (i.e., on the user's shopping list). Furthermore, the shopping application 17 may access or be accessed by the business systems 30 in order to identify product offers for the products in which the user is interested (i.e. on the user's shopping list). In some embodiments all or part of the shopping systems 10 may be included in the user systems 20, the business systems 30, some other systems related or unrelated to these systems.

As further illustrated in FIG. 2, the user computer systems 20 generally comprise a communication device 22, a processing device 24, a memory device 26, a data capture device 23, and a location determining device 25. The processing device 24 is operatively coupled to the communication device 22, the memory device 26, data capture device 23, and location determining device 25. The processing device 24 uses the communication device 22 to communicate with the network 2, and other devices on the network 2, such as, but not limited to, the shopping systems 10 and the business systems 30. As such, the communication device 22 generally comprises a modem, server, wireless card, and/or other device(s) for communicating with other devices on the network 2 and a display, camera, keypad, mouse, keyboard, microphone, and/or speakers for communicating with one or more users 4. The data capture device 23, as explained in further detail later, is used to capture information about products (i.e. product identifiers) to add to the products to the user's shopping list. The location determining device 25, as explained in further detail later, is used to determine the location of the user 4 through the location of the user systems 20 (i.e. mobile device 100).

As further illustrated in FIG. 2, the user computer systems 20 comprise computer-readable instructions 28 stored in the memory device 26, which in one embodiment includes the computer-readable instructions 28 of user applications 27. In some embodiments, the memory device 26 includes a datastore 29 for storing data related to the financial institution systems 20, including but not limited to data created and/or used by the user applications 27. The user applications 27 may include a data capture application 123, location determining application 125, e-mail application 124, web browser application 122, etc. The data capture application 123, as explained in further detail later may be utilized to capture product identifier data that is used to add products to a virtual shopping list. The location determining application 125, as explained in further detail later may be utilized to capture information regarding the user's current location and/or location over time, in order to provide offers to the user 4 based on one or more of the user's locations.

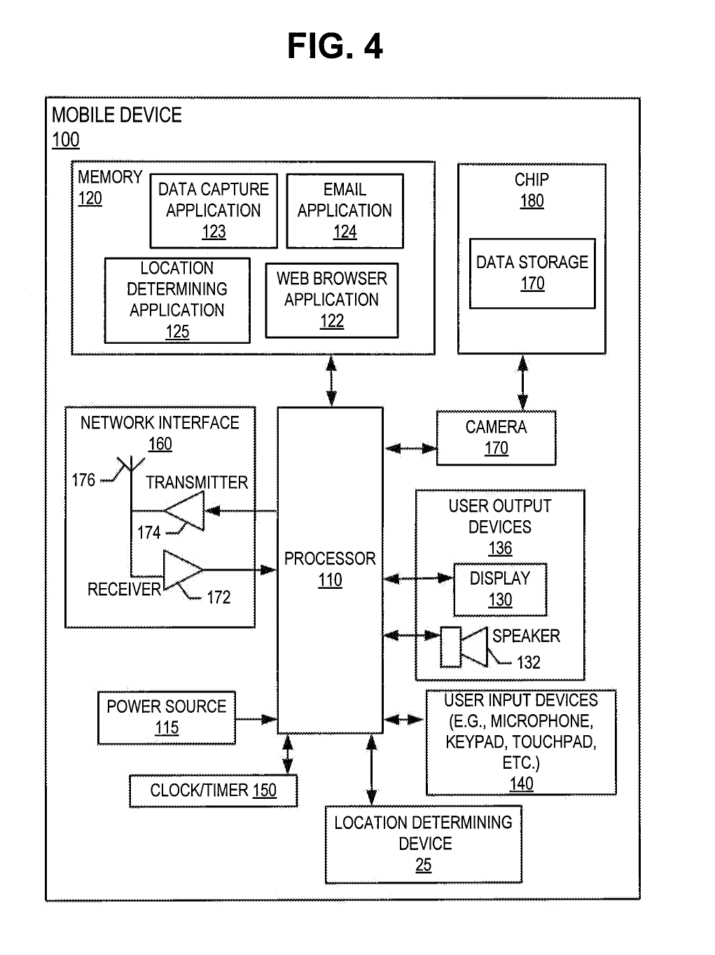

In some embodiments of the invention the user 4 is any user that utilizes the shopping system 10 to create a virtual shopping list in order to identify the best offers in terms of price, quantity, location, quality, etc. In some embodiments the user 4 may capture product identifiers from products and access the shopping application 17 using the user computer systems 20 in order to identify products in which the user 4 is interested (i.e., create a shopping list and/or view offers from business related to the products on the shopping list). The user 4 may be an individual or may be an employee, contractor, agent, officer, etc. that acts on behalf of a business. In some embodiments of the invention, the user computer systems 20 are mobile devices, as explained in further detail later with respect to FIG. 4. The users systems 20 (i.e., mobile device 100 with GPS or accelerometer, etc.) may be embedded directly in other products, such as but not limited to a car navigation system, other automotive system, sea vessel system, motorized vehicle system, manually powered vehicle system, etc.

As further illustrated in FIG. 2, the business systems 30 comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, shopping systems 10, and the user computer systems 20. As such, the communication device 32 generally comprises a modem, server, or other device for communicating with other devices on the network 2.

As further illustrated in FIG. 2, the business systems 30 comprise computer-readable instructions 38 stored in the memory device 36, which in one embodiment includes the computer-readable instructions 38 of business applications 37. In some embodiments, the memory device 36 includes a datastore 39 for storing data related to the business systems 30, including but not limited to data created and/or used by the business applications 37.

The business applications 37 may be applications that are used to interact with the shopping application 17 or user applications 27 to receive, process, store, and send information relating to offers for products in which the user is interested (i.e., on the user's shopping lists). In other embodiments the business applications 37 are simply used to provide offers to public or private systems and do not specifically interact with the shopping application 17, but allow the shopping application 17 to view product information through the network 2. The business applications 37 may comprise of a bid process application, an offer application, an ordering application, etc. In one embodiment the bid process application may allow the business to submit bids for one or more products on the shopping lists of users.

It is understood that the servers, systems, and devices described herein illustrate one embodiment of the invention. It is further understood that one or more of the servers, systems, and devices can be combined in other embodiments and still function in the same or similar way as the embodiments described herein.

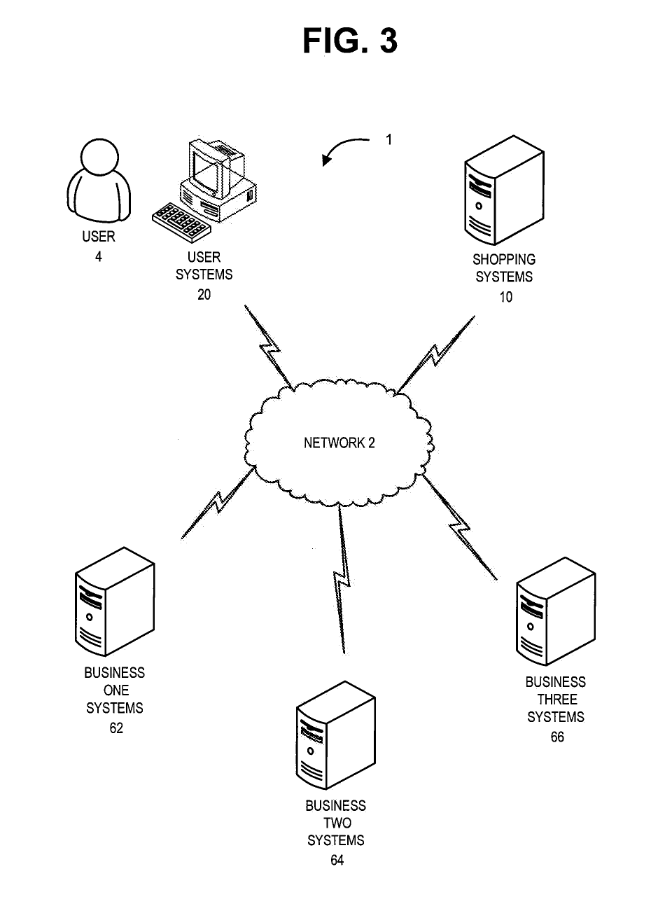

FIG. 3 illustrates another embodiment of the shopping system environment 1. As illustrated in FIG. 3, the shopping systems 10 are operatively coupled to the user systems 20, business one systems 62, business two systems 64, business three systems 66, etc. In this way the user can create a shopping list using the user systems 20, which is stored in or accessed by the shopping systems 10. The shopping systems 10 can transfer to or allow access by the one or more the businesses to the user's shopping list through the business systems 30 (i.e. business one systems 62, business two systems 64, business three systems 66, etc.). The shopping systems 10 can then receive offers from the one or more businesses for one or more of the products on the user's shopping list, and thereafter allow the user systems 20 to access the offers.

FIG. 4 illustrates one embodiment, wherein the user system 20 is a mobile device 100 that may be utilized to identify products in which the user 4 is interested (i.e., create shopping lists) and identify offers from businesses in which the user is interested. A “mobile device” 100 may be any mobile communication device, such as a cellular telecommunications device (i.e., a cell phone or mobile phone), personal digital assistant (PDA), a mobile Internet accessing device, smartphone, or other mobile device including, but not limited to pagers, mobile televisions, gaming devices, laptop computers, cameras, video recorders, audio/video player, radio, GPS devices, any combination of the aforementioned, or the like.

The mobile device 100 may generally include a processor 110 communicably coupled to such devices as a memory 120, user output devices 136, user input devices 140, a network interface 160, a power source 115, a clock or other timer 150, a camera 170, a location determining device 25, a chip 180, etc.

The processor 110, and other processors described herein, may generally include circuitry for implementing communication and/or logic functions of the mobile device 100. For example, the processor 110 may include a digital signal processor device, a microprocessor device, and various analog to digital converters, digital to analog converters, and/or other support circuits. Control and signal processing functions of the mobile device 100 may be allocated between these devices according to their respective capabilities. The processor 110 thus may also include the functionality to encode and interleave messages and data prior to modulation and transmission. The processor 110 may additionally include an internal data modem. Further, the processor 110 may include functionality to operate one or more software programs or applications, which may be stored in the memory 120. For example, the processor 110 may be capable of operating a connectivity program, such as a web browser application 122. The web browser application 122 may then allow the mobile device 100 to transmit and receive web content, such as, for example, location-based content, data capture content, and/or other web page content, according to a Wireless Application Protocol (WAP), Hypertext Transfer Protocol (HTTP), and/or the like.

The processor 110 may also be capable of operating user applications 27, such as a data capture application 123 (i.e. an AR application), a location determining application 125, e-mail application 124, web browser application 122, etc. The user applications 27, or a portion of thereof, may be downloaded from a server and stored in the memory 120 of the mobile device 100. Alternatively, the user applications 27 may be pre-installed and stored in a memory device 120. In such an embodiment, the user 4 may not need to download the user applications 27 from a server. In some embodiments the user applications 27 may be stored on a server and the mobile device 100 can access the user applications 27 in order to access the functionality of the user applications 27 over a network 2.

The data capture application 123 may work in conjunction with a data capture device 23 (i.e. camera 170, scanner, barcode reader, optical reader, etc.) that is used to capture product identifiers related to products in which the user 4 is interested. The data capture application 123 receives the product identifier captured about the product, such as but not limited to an image, video, barcode, digitized information, etc. and identifies information about the product in which the user 4 is interested. The user 4 can add the product and associated product information to a virtual shopping list, in order to receive offers for the product from one or more businesses. In one embodiment of the invention the data capture application 123 is an AR application. As explained in further detail later, the AR application may be used to identify information from images or videos captured using the mobile device in real-time or after the images or videos are captured.

The location determining application 125 works in conjunction with the location determining device 25 to identify the location of the user 4 based on the location of the mobile device 100. In some embodiments the location determining device 25 is a GPS system that may only be accurate up to approximately 3 meters. In other embodiments of the invention the location determining device 25 is an accelerometer. An accelerometer is sensitive enough to detected small movements in tilt, position, etc. of the user 4. For example, the accelerometer may have the ability to detect when the mobile device 100 is located in the user's hand verses when it is sitting on a table. This type of accuracy may be able to identify when a user 4 is using the mobile device 100 (or other type of device) in the user's hand, but is not physically moving in a particular direction. The location determining application 125 may track the location of the user 4, body movements, or other user information, over a time interval, such as a minute, hour, day, week, etc. or at a specific point in time, such as the current user location, a user location at noon, etc. The location determining device, as explained in further detail later, allows the user 4 to receive offers from businesses based on the user's past, present, and/or future location.

The processor 110 may be configured to use the network interface 160 to communicate with one or more other devices on a network 2. In this regard, the network interface 160 may include an antenna 176 operatively coupled to a transmitter 174 and a receiver 172 (together a “transceiver”). The processor 110 may be configured to provide signals to and receive signals from the transmitter 174 and receiver 172, respectively. The signals may include signaling information in accordance with the air interface standard of the applicable cellular system of the wireless telephone network that may be part of the network. In this regard, the mobile device 100 may be configured to operate with one or more air interface standards, communication protocols, modulation types, and access types. By way of illustration, the mobile device 100 may be configured to operate in accordance with any of a number of first, second, third, and/or fourth-generation communication protocols, etc. and/or the like. For example, the mobile device 100 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 100 may also be configured to operate in accordance with non-cellular communication mechanisms, such as via a wireless local area network (WLAN) or other communication/data networks.

The data capture device 23, in some embodiments may be a camera 170 that is used to capture images and video of a product identifier and the data capture chip 180 is an AR chip that includes the necessary circuitry to provide the AR functionality to the mobile device 100, which is utilized to determine information from the product identifiers in the images and/or video. Generally, the AR chip may include data storage 171 which may include data associated with the objects within a real-time video stream that the AR application identifies as having a certain AR marker(s). The AR chip and/or AR data storage 171 may be an integrated circuit, a microprocessor, a system-on-a-chip, a microcontroller, or the like. As discussed above, in one embodiment, the AR chip may provide the AR functionality to the mobile device 100. In some embodiments some or all of the AR data storage for the data associated with objects within AR may be located outside of the mobile device 100, such as on another computer or sever, with which the mobile device 100 can communicate to access and/or store data associated with products based on the captured product identifiers.

Of note, while FIG. 4 illustrates the AR chip as a separate and distinct element within the mobile device 100, it will be apparent to those skilled in the art that the AR chip functionality may be incorporated within other elements in the mobile device 100. For instance, the functionality of the AR chip may be incorporated within the mobile device memory 120 and/or processor 110. In a particular embodiment, the functionality of the AR chip is incorporated in an element within the mobile device 100 that provides AR capabilities to the mobile device 100. Still further, the AR chip 180 functionality may be included in a removable storage device such as an SD card or the like.

The network interface 160 may also include an AR interface in order to allow a user to execute some or all of the above-described processes with respect to the AR application and/or the AR chip. The AR interface may have access to the hardware, e.g., the transceiver, and software previously described with respect to the network interface 160. Furthermore, the AR interface may have the ability to connect to and communicate with an external AR data storage on a separate system within the network 2.

As described above, the mobile device 100 may have a user interface that includes user output devices 136 and/or user input devices 140. The user output devices 136 may include a display 130 (e.g., a liquid crystal display (LCD) or the like) and a speaker 132 or other audio device, which are operatively coupled to the processor 110. The user input devices 140, which may allow the mobile device 100 to receive data from a user 4, may include any of a number of devices allowing the mobile device 100 to receive data from a user 4, such as a keypad, keyboard, touch-screen, touchpad, microphone, mouse, joystick, other pointer device, button, soft key, and/or other input device(s). In some embodiments of the invention the user input devices 140 may be considered data capture devices 23.

In some embodiments, the processor 110 may also be capable of operating one or more applications, such as one or more applications functioning as an artificial intelligence (“AI”) engine. The processor 110 may recognize objects that it has identified in prior uses by way of the AI engine. In this way, the processor 110 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

The mobile device 100 may further include a power source 115. Generally, the power source 115 is a device that supplies electrical energy to an electrical load. In one embodiment, power source 115 may convert a form of energy such as solar energy, chemical energy, mechanical energy, etc. to electrical energy. Generally, the power source 115 in a mobile device 100 may be a battery, such as a lithium battery, a nickel-metal hydride battery, or the like, that is used for powering various circuits, e.g., the transceiver circuit, and other devices that are used to operate the mobile device 100. Alternatively, the power source 115 may be a power adapter that can connect a power supply from a power outlet to the mobile device 100. In such embodiments, a power adapter may be classified as a power source “in” the mobile device.

The mobile device 100 may also include a memory 120 operatively coupled to the processor 110. As used herein, memory may include any computer readable medium configured to store data, code, or other information. The memory 120 may include volatile memory, such as volatile Random Access Memory (RAM) including a cache area for the temporary storage of data. The memory 120 may also include non-volatile memory, which can be embedded and/or may be removable. The non-volatile memory may additionally or alternatively include an electrically erasable programmable read-only memory (EEPROM), flash memory or the like.

The memory 120 may store any of a number of applications or programs which comprise computer-executable instructions/code executed by the processor 110 to implement the functions of the mobile device 100 described herein. For example, the memory 120 may include such applications as a web browser application 122, data capture application 123 (i.e. AR application), e-mail application 124, location determining application 125, an SMS application, etc.

FIG. 1 provides a high level process flow illustrating a shopping list offer process 80, in accordance with one embodiment of the invention. As illustrated by block 82 in FIG. 1, the shopping systems 10 identify products on a user's shopping list. In some embodiments of the invention, identifying products comprises first receiving a request to add products to a user's virtual shopping list. For example, the user 4 may add a product to the shopping list by capturing product identifiers of products using a data capture device 23, as previously described. In some embodiments of the invention the data capture device 23 may be a camera 170 that is used to capture an image of a product identifier, and thereafter the image is scrutinized to determine information about the product. In some embodiments of the invention the data capture device 23 may be a user input device 140, such as a touchscreen that allows the user to enter information about a product into the mobile device to add a product to a shopping list. The user 4 may access the shopping application 17 in order to add a product to the shopping list stored on the shopping systems 10, or alternatively, the user 4 may add a product to a shopping list stored on the user systems 20 that the shopping systems 10 may access for identifying products on the shopping list. As previously discussed the user 4 may sort the products on the shopping list into one or more lists based on various attributes, such as but not limited to, price, type of product, stores at which the product may be purchased, etc. After the user 4 has created the shopping lists the shopping systems 10 may identify information about the one or more products on the shopping lists so that the shopping systems 10 may identify offers that businesses are offering for the same or similar products.

As illustrated by block 84 in FIG. 1, the shopping systems 10 communicate with the business systems 30 in order to determine the offers that the businesses may provide based on the products on the shopping list. In one embodiment of the invention, the shopping systems 10 may transfer the shopping lists and/or the products thereon to the one or more businesses, or alternatively, the businesses may access the shopping lists on the shopping systems 10. The businesses, as explained later, may participate in a bid auction process in which the businesses bid on one or more, or all of, the products on the shopping lists of the users 4. In other embodiments of the invention the shopping systems 10 communicate with the business systems 30 to identify the offers available for the products on the user's shopping lists. In some embodiments of the invention the shopping systems 10 may do this by accessing public or private web pages and/or databases of the businesses to determine the best offers available for the products on the user's shopping lists. The best offers may be based on product prices, quantity, quality, locations to purchase, etc. For example, the lowest price may be identified as the best offer, a highly rated customer quality product may be identified as the best offer, a package having the largest quantity may be identified as the best offer, a business selling the product that is located nearest to the customer may be identified as the best offer, etc.

As illustrated by block 86 in FIG. 1, the shopping systems 10 may determine the best offers that the businesses have for the products on the user's shopping list. In some embodiments, determining the best offers may be done by identifying the best bids made by the businesses for the products, identifying the best public offers the businesses have available (i.e. by accessing public websites and/or databases), indentifying the best private offers that businesses have available (i.e. by accessing private websites and/or databases), etc. In some embodiments of the invention the shopping systems 10 may not identify only the best bids, but may instead identify some or all of the available offers that businesses have for the users 4. Thereafter, the individual users 4 can determine what offers to accept and what offers to reject.

As illustrated by block 88 in FIG. 1, the offers are made available to the users 4 for review. In some embodiments the shopping systems 10 may transmit the offers to the user systems 10. In other embodiments the users 4 may access the shopping systems 10 in order to view the available offers. In some embodiments only the offers that are determined to be the best offers are made available to the users 4. Again, the best offers may include the offers with the lowest price, most quantity, best quality ratings, best locations in terms of the closest to the user's current, home, work, etc. location. In other embodiments of the invention all of the offers may be provided to the user so that the user can identify the offers for the products on the shopping list in which the user is interested.

As illustrated by block 90 in FIG. 1 the user selects an offer. In some embodiments the shopping system 10 may receive a selected offer from the user systems 20, or in other embodiments, the user 4 may access his/her shopping list in the shopping systems 10 in order to the select the offers in which the user 4 wants to purchase.

As illustrated by block 92 of FIG. 1 the selected offer is made available to the one or more businesses to finalize the transaction. In some embodiments, the offers selected by the user 4 are sent to the one or more businesses by the shopping systems 10. In other embodiments of the invention the businesses systems 30 may access the shopping systems 10 in order to determine the offers selected by the user 4. In some embodiments of the invention the business systems 30 may receive the selected offers directly from the users 4 by accessing the user systems 20 or alternatively by allowing the users 4 to access the business systems 30.

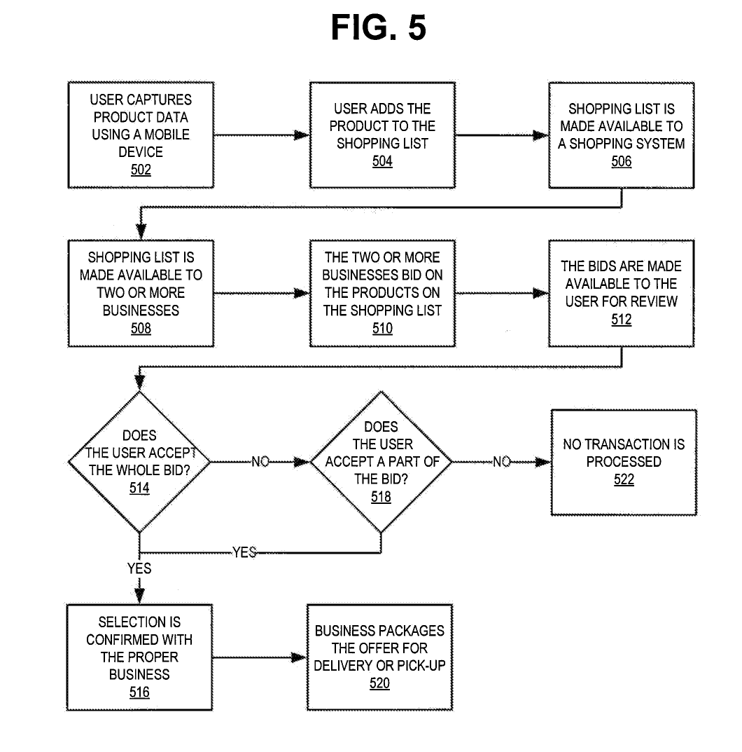

FIG. 5 illustrates a shopping list bid process 500, in accordance with an embodiment of the invention. The shopping list bid process 500 allows one or more businesses to bid on the products on a user's shopping lists. The user's shopping lists are made available to the businesses, thereafter, the businesses bid on fulfilling the entire shopping list or specific products within the shopping list, and make offers to the user 4. The bids are evaluated by the user 4, and the user 4 may select one or more of the offers in order to enter into transactions with the one or more businesses for the products on the shopping list. The selected offers are transferred to the one or more businesses in order to fulfill the selected orders.

As illustrated by block 502 in FIG. 5, the user may capture product identifiers using a mobile device 100 in a number of different ways as previously explained using the data capture device 23 and data capture application 123. As illustrated by block 504 the user 4 can add one or more of the products captured in block 502 to a shopping list, as previously described. For example, a user 4 may capture information about products from a grocery store and home improvement store by capturing an image of the product barcode, or by selecting the product through a website using a touchscreen or keypad. The products captured may be added to the user's shopping list by selecting the information about the products using the touchscreen or keypad. In some embodiments the products may be added to the shopping list directly when the user 4 captures information about the products using the data capture device 23 and data capture application 123. In some embodiments of the invention all of the products may be included on a single shopping list, however, in other embodiments of the invention the user 4 and/or the shopping application 17 may place the products in various categories. For example, food items may be placed in a grocery shopping list, while cleaning supplies are placed in a home improvement shopping list.

As illustrated by block 506, the shopping list may be received by a shopping system 10 from the user systems 20, or in alternative embodiments, the shopping system 10 may access the shopping list stored on the user systems 20. For example, the user's shopping lists, such as a grocery list and home improvement list may be sent to the shopping system 10 so that the shopping system 10 can identify available offers for the products on the shopping lists.

The shopping list may be made available to two or more businesses, as illustrated by block 508 in FIG. 5. The shopping list, in one embodiment may be transmitted to the systems of two or more businesses. For example, in one embodiment, the shopping systems 10 may transmit the shopping list to the business one systems 62, business two systems 64, business three systems 66, etc. In other embodiments, the shopping list may be accessed by the businesses on the shopping systems 10. For example, the business one systems 62, business two systems 64, and business three systems 66 may communicate with the shopping systems 10 in order to access the shopping lists of users stored on the shopping systems 10.

As illustrated in block 510 the two or more businesses bid on the one or more products on the user's shopping lists. For example, the businesses may bid on the user's entire shopping list, such that the businesses would provide all of the products on the user's shopping list. For example, in the case where the shopping list is a grocery list, various grocery stores bid on supplying all of the grocery products on the user's shopping list for a total price. In some embodiments a business (i.e. grocery store, or any other businesses involved in the bid process) may not have all of the products on the user's shopping list in the store. In these scenarios the business may substitute a product on the user's shopping list with a similar product that the store actually carries. For example, store brand X may be on a user's shopping list. Business X can supply brand X because business X makes brand X, however, business Y would substitute brand X with brand Y because business Y makes brand Y not brand X. In other examples, the shopping list may be a remolding product, in this embodiment different contractors may bid on the remolding product and the user 4 can select the bids for one or more the contractors. In other examples, the shopping list may include high priced electronic devices, cars, boats, etc. Various businesses may bid on providing the products to the user 4 a specified price.

After the businesses bid on the products on the shopping list the offers are made available to the user 4 for review, as illustrated by block 512 in FIG. 5. In some embodiments the offers based on the bid auction are sent directly to the user systems 20, however, in other embodiments the offers based on the bids are sent to the shopping systems 10, which either sends the offers to the user systems 20 or allows the user systems 20 to access the offers located on the shopping systems 20. For example, a first grocery store may offer to provide all of the products on the user's shopping list for $180 dollars, while a second grocery store may provide all of the products on the user's shopping list for $200.

As illustrated by decision block 514, the user 4 may decide to accept the entire offer provided by a business. If the user 4 accepts the whole bid, a notification of the selection (i.e. acceptance) is sent to the proper business directly from the user systems 20, directly from the shopping systems 10, from the user systems 20 through the shopping systems 10, etc., as illustrated by block 516 in FIG. 5. For example, the user 4 may select to fulfill the shopping list using the first grocery store that bid $180 on the shopping list. In many cases the best offer for the user is the grocery store that provides the products for the lower price. However, in some embodiments the user 4 may feel that the second grocery store's bid (i.e. $200) provides better quality food, or is located closer to the user's home, and thus may choose that the best offer is the second grocery store.

As illustrated by block 520, the business may ship the products if they are goods or provide the products if they are services to the user 4, or the user may pick up the products or use the services at the location of the business. For example, in the case of a grocery store, the store may assemble the products on the shopping list purchased by the user so that the user 4 need only pick up the products at the store. The user 4 may pay for the products before reaching the store over the network 2 or at the store location after the user has arrived.

If the user does not accept the whole bid, the user 4 may decide to accept a part of the bid, as illustrated by decision block 518. In some embodiments the user 4 may want to purchase various products from multiple stores using bifurcated offers from two or more businesses. For example, again in the case of grocery store, a first store may bid $100 for food products and $80 dollars for cleaning products (total $180), while a second store may bid $90 for the same food products and $110 dollars for the same cleaning products (total $200). Thus, the user 4 may want to purchase the cleaning products at the first store and the food products at the second store (total $170) in order to get the products for the lowest price. After the user 4 selects the offers from the one or more businesses, the selection is sent to the proper businesses to have the offers fulfilled, as illustrated in block 516. Thereafter, the businesses fulfill the offers and have the products waiting for the user 4 when the user 4 arrives, as previously discussed.

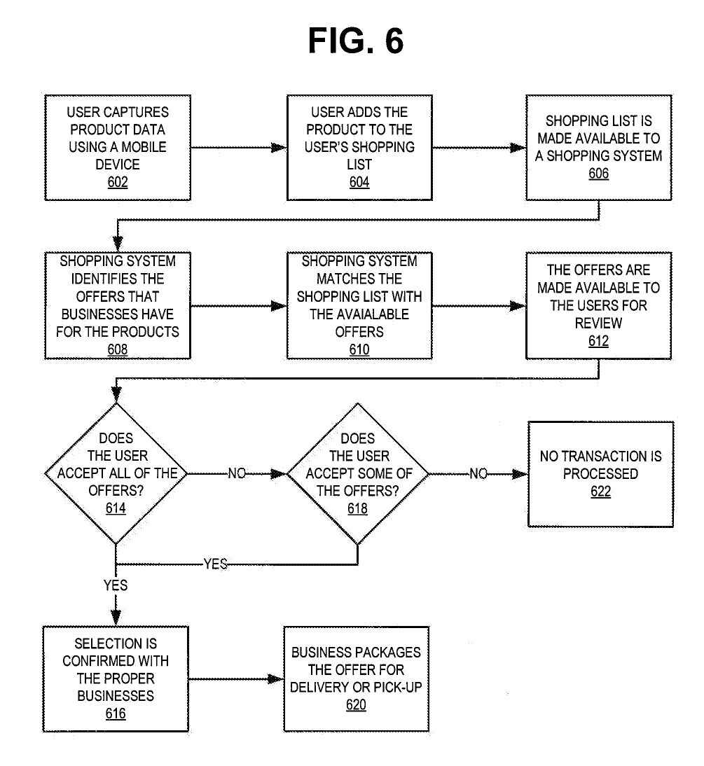

FIG. 6 illustrates a process flow for a shopping list offer determination process, in accordance with embodiments of the invention. In this process offers are determined by the shopping systems 10 by accessing websites and/or databases of businesses and/or allowing businesses to upload product data to the shopping systems 10 in order to determine the prices, quantity, quality, locations, etc. of products that the users 4 can purchase.

As illustrated by block 602 the user may capture product identifiers using a mobile device, as previously explained herein. Thereafter, the user 4 may add the products to the user's shopping list by utilizing the product identifiers captured by the user 4, as illustrated by block 604, and as previously explained. The shopping systems 10 may receive the user's shopping list, as illustrated in block 606. In some embodiments the shopping list may be sent to the shopping systems 10 by the user systems 20, or in other embodiments the shopping systems 10 may access the user systems 20 to identify the shopping list and the products thereon.

As illustrated by block 608 in FIG. 6, in this embodiment the shopping systems 10 communicate with the business systems 30 to determine the offers for the products on the shopping lists instead of participating in a bid auction process. The offers may be determined in number of different ways. In one embodiment, the shopping systems 10 may access public information that is available over the network 2, such as websites and public databases that disclose the prices, quantity, quality, location, etc. of the products offered by various businesses. In other embodiments of the invention, the shopping systems 10 may access private information regarding products offered by the various businesses. The private information may be located in secure locations (i.e. websites, databases, etc.) with which the shopping systems 10 are allowed to communicate. The secure locations may include pricing, quantity, quality, location, etc. information related to the products that are offered by the businesses. In other embodiments of the invention the businesses may upload product information (i.e. price, quantity, quality, location, etc.) to the shopping systems 10, such that the shopping systems may be able to identify offers for products on the user's shopping list by identifying the product information uploaded to the shopping systems 10. In some embodiments of the invention, the shopping system 10 may use one or more of the techniques described herein to identify offers provided by various businesses. Thus, the shopping system 10 has the ability identify the potential offers for product on users' shopping lists from multiple businesses.

As illustrated by block 610, the shopping system 10 may assemble the offers for the users 4 based on price, quantity, quality, location, etc. and match the identified offers with the products on the user's shopping lists. Thereafter, the offers may be sent to the user 4 for review, as illustrated by block 612. For example, in some embodiments the shopping system 10 may identify that the user 4 is interested in purchasing various products from a home improvement store. The shopping systems 10 may access the public websites of multiple different home improvement stores to match the products on the user's shopping list with the prices of the products at the home improvement stores. The shopping systems 10 may provide the user 4 with the total prices that each home improvement store would charge for the products on the user's shopping list. In other embodiments of the invention the offers may be based on the quantities needed by the user 4. For example, if the user 4 needed ten (10) doors from a particular home improvement store, the shopping systems 10 may identify not only the where the user 4 could get the door, but the shopping systems 10 may interact with the business systems 30 to determine what stores actually had the quantity of the products in which the user 30 is interested.

As previously explained with respect to FIG. 5, the user may request to purchase all of the offers from a particular store, as illustrated by decision block 614, some of the offers as illustrated by decision block 618, or none of the offers, as illustrated by block 622 of FIG. 6. Based on the offers selected by the user 4, the selections are sent to the proper businesses and the businesses fulfill the orders, as illustrated by blocks 616 and 620.

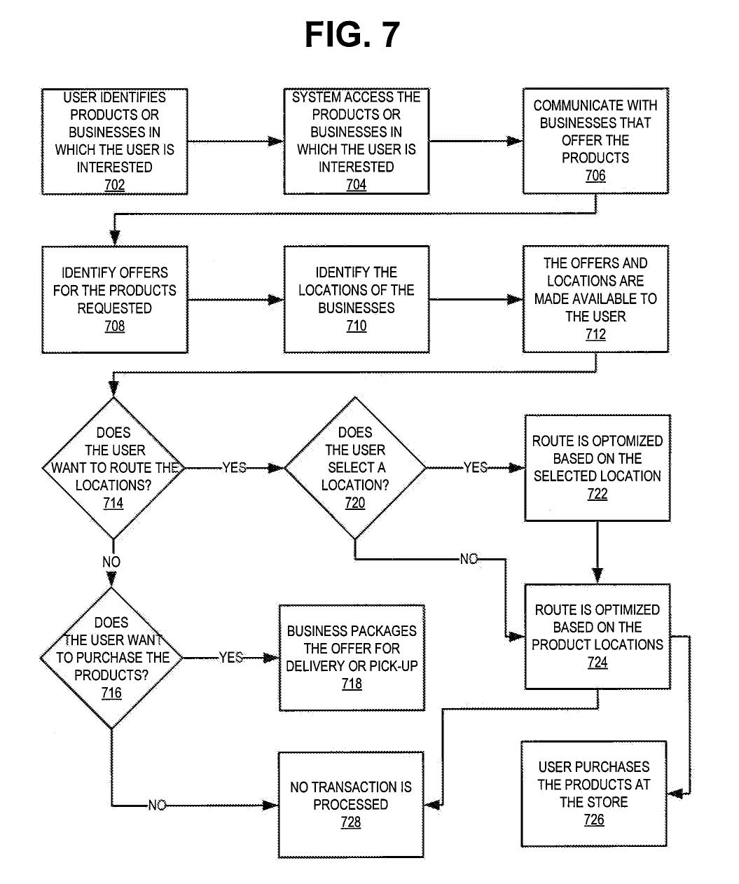

FIG. 7 illustrates a process flow for an optimized offer routing process 700, in accordance with an embodiment of the invention. As described in further detail with respect to FIG. 7 below, a user 4 may request or express interest in two or more products from various businesses, or the businesses themselves, in a number of ways in order to receive offers from the businesses and thereafter receive optimized routes for finding the locations of the businesses. In one embodiment the request for products may be made through the use of the shopping lists as described above, but in other embodiments the request for products may be made in a number of different ways as described in more detail below. The optimized route for traveling to various businesses that provide offers for the products in which the user 4 is interested may also be based on a user location. The user location may be the current, past, or future location of the user 4 or any other location in which the customer is interested. The location may be automatically identified by the shopping systems 10, or, in some embodiments, may be selected by the user 4. The optimized route may be one or more different routes to one or more locations, over the span of one or more days, that can be taken by one or more people, as explained in further detail below.

As illustrated in block 702, the user 4 identifies his or her interest in one or more products or businesses. In some embodiments the identification may be through a request to receive offers for products. In these instances, as previously explained with respect to blocks 502 and 602 in FIGS. 5 and 6, this step may include a user 4 capturing product identifiers utilizing the user computer systems 20 (i.e. a mobile device 100). Thereafter, the user may add the products associated with the product identifiers to a shopping list, as previously explained with respect to blocks 504 and 604 in FIGS. 5 and 6. In alternate embodiments of the invention the request for offers related to products may be made to a shopping system 10 by directly indicating the products and/or businesses in which the user 4 is interested without adding them to a shopping list. In other embodiments the user may receive one or more offers without requesting information about the products. For example, the user 4 may receive offers for products through e-mail marketing campaigns, through traditional e-mail campaigns, through text messages alerts, through pop-up adds on the internet, through business' websites, on online communities, etc. The user 4 may identify (i.e. select) these one or more offers as a product or business in which the user 4 is interested. The information may be transferred to the shopping systems 10 or the user 4 may allow the shopping systems 10 to access these offers. For example, the user 4 may indicate to the shopping system 10 that the user 4 wants to eat at particular restaurant or wants to eat a type of food, wants to purchase some groceries, and wants to purchase some cleaning supplies all within one or more trips.

Regardless of how the products or businesses in which the user 4 is interested are identified, the shopping systems 10 access information about the products or businesses as illustrated by block 704. In the case of products on a shopping list, the shopping systems 10, as previously discussed with respect to blocks 506 and 606 in FIGS. 5 and 6, may access the shopping list on the user systems 20 or may receive the shopping list from the user systems 20. In other embodiments the user 4 may transfer the products or businesses in which the user is interested, or the shopping systems 10 may identify the products or businesses by accessing the user systems 20 in the same or similar way as they would while accessing a shopping list. In other embodiments, the shopping systems 20 may be monitoring products and businesses that send information to the user 4, or content in which the user is viewing over the network 2. For example, in practice the shopping systems 10 may receive product selections from the user 4, may receive products in which the user is interested from one or more businesses from which the user 4 may be communicating, may identify the products based on user 4 transaction information for a single purchase or over time, may identify the products based on user 4 profile information, etc.

The shopping systems 10 may communicate with one or businesses that offer products or fit the description of businesses in which the user is interested, as illustrated by bock 706. As previously explained, communicating may include accessing public or private websites and/or databases of the one or businesses, allowing the businesses to access public or private websites and/or databases of the shopping systems 10, receiving uploaded information about the one or more businesses, etc.

As illustrated by block 708 in FIG. 7, the shopping systems 10 may identify the offers provided by the businesses based on the products or locations in which the user 4 is interested. As previously discussed herein, the offers for the products may be identified through the use of a shopping list in a bid auction as described in the bid auction process 500 as explained in FIG. 5, or by searching private and/or public websites and/or databases as described in the shopping list offer determination process 600 as explained in FIG. 6. However, in other embodiments of the invention the offers may simply be identified by receiving offers from the one or more businesses for a variety of products in which the user may or may not be interested. Thereafter, the shopping system 10 may identify (i.e. match) products in which the user 4 is interested in with offers that have been received by the one or more businesses.

As illustrated by block 710 in FIG. 7, the locations of the businesses supplying the products in which the user 4 is interested are identified. In order to optimize the routes for the user 4, the shopping systems 10 identify the locations of the one or more businesses involved in providing offers to the users 4. The locations of the businesses may be identified utilizing websites, databases, directories, GPS information, or any other technology that provides location information for businesses.

As illustrated by block 712 in FIG. 7, the offers and associated locations of the businesses providing the offers are made available to the user 4 for review. In other embodiments of the invention the locations may only be provided to the user 4 if the user has selected particular offers from one or more businesses.

As illustrated by decision block 714, in some embodiments the user 4 determines whether or not to have the shopping systems 10 (or other systems) optimize the route that a user 4 can take to procure the products from the one or more businesses that offer products in which the user 4 is interested. In some embodiment the products may be identifying from the user's shopping list, however, in other embodiments they may be products or businesses identified as described with respect to blocks 702 through 708.

As illustrated by decision block 720 the user 4 may also select one or more locations from which to optimize a route to purchase one or more products in which the user 4 is interested. In other embodiments the optimized route may be based on businesses near a location identified automatically by the shopping systems 10 in addition to the location of products and/or businesses in which the user is interested.

Regardless if the location is selected by the user 4 or determined automatically by the shopping systems 10 the location may be a current, past, or potential future location of the user 4. In some embodiments the optimized route for one or more products in which the user is interested may be based on the user's current location. The shopping systems 10 may route the user 4 to the closest locations from the user's current location at which the user 4 can purchase the products in which the user 4 is interested.

In other embodiments the optimized route may be based on a location at which the user 4 may potentially be in the future. For example, the user 4 may know that later in the day he or she is planning on being at a particular restaurant, but also wants to purchase a number of products that can be found at a grocery store and a home improvement store. The shopping systems 10 (or other systems) may optimize the user's route from home to the restaurant and back home after the restaurant to provide the user 4 with the lowest priced products at stores that are located along or near the route to and/or from the restaurant. For example, the shopping systems 10 may inform the user that the grocery products would be the lowest price at a grocery store near the home of the user 4 as opposed other grocery stores along the route to the restaurant. Furthermore, the lowest price for the home improvement products would be the lowest price at a store near the restaurant as opposed to a store near the user's home or along the route to the restaurant. Thus, the shopping system 10 optimizes the user's route to the restaurant by providing the location of the home improvement store to the user 4 on the way to the restaurant and the location of the grocery store to the user 4 on the way back from the restaurant, or visa versa. Alternatively, the shopping system may provide the location of the both of the stores on the way to the restaurant or the way back from the restaurant.

In some embodiments of the invention, the optimized route may based on a past location of user 4, such that the shopping systems 10 may provide an optimized route for locations to purchase products in which the user is interested near locations that the user 4 has frequented in the past, such as the user's place of work, a vacation spot the user visits, a commercial district that the user is often passing, etc. For example, the location determining device 25 of the mobile device 100 may track the location of the user 4 over time. Therefore, when the user 4 wants to purchase products from a grocery store, the shopping systems 10 may route the user 4 to a particular store that the user 4 often frequents as opposed to a store that may be closer to the user 4, but that the user 4 has not visited before.

In some embodiments the route may be optimized based on one or more of the products in which the user is interested (i.e., on the user's shopping lists, identified by the user 4, identified by the shopping systems 10, etc.) in conjunction with the hours of operation of the stores and the times at which the user 4 may be at a particular location. For example, in some embodiments of the invention the shopping systems 10 may optimize the route for providing a store location on the way to a restaurant because by the time the user 4 is on his or her way home from the restaurant the store may be closed. Therefore, in some embodiments the user 4 may provide a location at which the user 4 may potentially be in the future as well as a time frame that the user 4 will be at the location.

As illustrated by block 722, the route is optimized by the shopping system 10 (or other systems performing the optimization) based on the location selected by the user 4 (or identified by the shopping systems 10), and one or more of the products in which the user 4 is interested, the time the user 4 will be at the location, the store hours, customer history information, customer profile information, business discounts, or one or more other user 4 or business attributes.

If the user does not select a location, either past, current, or future. The route may simply be optimized based on the locations of the stores that carry the products in which the user 4 is interested, as illustrated by decision block 720 and block 724. For example, the route between a grocery store, home improvement store, restaurant, etc. may be provided to the user 4, regardless of the user's location, based on the locations of the stores that have the best offers and the restaurant. Whether or not the user 4 decides to select a location the user 4 may or may not decide to select the products for purchasing, as illustrated by blocks 726 and 728.

As illustrated by decision block 714, even if the user does not indicate that he or she wishes to route the locations of the products in which the user 4 is interested, the user 4 may still decide to purchase the products, as illustrated by decision block 716. If the user 4 selects one or more of the offers provided by the businesses, the user 4 may have the products delivered, or alternatively, travel to the store to receive the products, as illustrated by block 718. In some embodiments, the user 4 may decide not to enter into a transaction with the businesses at this time, as illustrated by block 728.

In some embodiments of the invention the optimized route could be optimized not based on a single route for identifying the location of products, but based on two or more routes. For example, a user 4 may be a business that operates a delivery or pick-up service. In other embodiments the user 4 could be a family that is planning to run a number of errands on a weekend. Regardless of the user 4 the optimized route may be determine for two or more routes based on two or more products. The products in which the user 4 is interested may be determined as described herein (i.e., shopping list, marketing program, selected by the user 4, etc.) and the routes for picking up the products can be optimized based on the products and single or multiple starting locations, the number of people that can take a route, the number of vehicles, the number of end locations, stops along the way, etc. These may all be identified manually by the user 4 or automatically by the systems described herein. For example, a business may need to pick up supplies from multiple locations and bring the supplies back to one or more job sites, cross-docking areas, warehouses, etc. A contractor may need to pick up wood from one location, granite from another location, and pipes from a third location. The routes may be optimized based on the location of the contractor's business, the one or more employees that are located at the contractor's business or located in the field with one or more trucks, and/or the end delivery locations of the materials. The optimized route may be for one truck to pick up the granite and a second truck to pick up the wood and pipes. The route may further be optimized for the two trucks to deliver the products to the job site, meet at a location to consolidate the load into one truck, deliver the material back to the contractor's business for delivery in the future, etc. Therefore, the present invention may be utilized as a logistic management tool for businesses (small or large) to optimize the employee time, gas prices, truck operation, delivery schedules, etc.

In other embodiments of the invention, for example in the case of a family with shopping lists for a grocery store and a home improvement store, the optimized routing may be useful for identifying two routes for two different members of the family to purchase the products instead of optimizing a single route for both locations. For example, the optimized route may be one route that takes a family member to a grocery store located near the home at which the family member is currently located to purchase products on a grocery list, and a second route that takes a family member who is already across town to a home improvement store that is located near the second family member in order to purchase the products on the home improvement shopping list. In this way, the routes to purchase the products are optimized because the first family member does not have to drive all the way across town to pick up the products from the home improvement store since the second family member is already near the location of the home improvement store.

The optimized route may also be split up between days based on where the user 4 may be in the future. For example, in one embodiment the optimized route may direct the user to a grocery store on Sunday in order to make purchases at the grocery store on Sunday, but direct the user 4 to a home improvement store on Monday when the user 4 returns to work because the home improvement store with the best offers is located close to the user's work. In this way the user 4 does not unnecessarily make a trip to the home improvement store on a Sunday when the user 4 is going to be near the store on Monday.

In some embodiments of the invention, discounts may be offered by the businesses on the products in which the user 4 is interested (i.e. on the user's shopping list, etc.) based on potential transactions between the user 4 and businesses, offers made by other businesses, the user's purchasing history, the user's demographic information, geo-positioning information of the user, etc. Therefore, either the types of offers provided to a user 4 or the optimized routes to pick up the products may be based at least in part on discounts. For example, in some embodiments the one or more products on a shopping list may be discounted by a single business if the user 4 agrees to purchase all of the products from the single business. The businesses may also match bids or offers by other businesses, such that one or more businesses may apply a discount to one or more products if the products are being offered at a lower price by another business. Discounts may also be offered to users 4 based on the user's transaction history. For example, a business may offer discounts only to the users 4 that made a number of purchases with the business, spent at least a specific amount of money with the business, have never made any transactions with the business before, etc. Discounts may also be offered to users 4 based on user demographic information, such as a user's age, income, political affiliation, etc. For example, if a business sells most of its products to males that are over 50 years of age the business may offer discounts for products on the user's shopping list to users 4 who are over this age. In some embodiments of the invention, discounts may be offered based on geo-positioning information. For example, if a business knows that a user 4 is frequently near the store based on the location determining device 25 in the mobile device 100, the business may offer the user 4 a discount in order to entice the user 4 to shop at the business. The business may also provide a discount to make the price of a product on the user's shopping list, or other product in which the user 4 may be interested, less than the price of the same or similar product that another business is offering.

In some embodiments of the invention, a rewards system (i.e., reward cards, loyalty cards, etc.) may be used to identify offers or optimize a route for a user 4. For example, with respect to a shopping list, the offers made to a user 4 may be based on the user's reward programs. The best offer identified for the user 4 may be based on the rewards that the user 4 can receive for selecting an offer through a specific business. For example, a user 4 may receive bids or be presented with two offers for products that have the same value; however, the user may receive reward points, miles, discounts, etc. for selecting an offer that is tied to a rewards program with which the user 4 is affiliated. Therefore, the offer tied to the rewards program may be identified as the best offer. With respect to optimizing a route for the user 4, the businesses provided in the optimized route may be based on rewards that a user 4 may receive for entering into a particular transaction with a particular business.

In some embodiments offers may also be based in part on customer transaction history and/or customer profile data. For example, an offer may be made to a user 4 on Wednesday as opposed to Saturday because the customer transaction history information may indicate that a particular user 4 is more likely to purchase the product on a weekday than on the weekend. Furthermore, the offer may be based on demographic information about user 4 as opposed to the transaction history of a single user. For example, demographic information may indicate that users 4, in general, like to shop for groceries on a Wednesday instead of a Saturday. Therefore, in some embodiments of the invention the offers provided to a user 4 for products in which the user 4 is interested may be based at least in part on other users 4 that have the same or similar demographic information as the user 4.

In some embodiments of the invention the shopping systems 10 may be run by a financial institution that only has some of the information related to products that the user 4 purchases from a store. For example, the shopping systems 10 may only have access to locations at which the user 4 made the purchase, and the total amount of the purchase made. Therefore, it may be difficult for the shopping systems 10 to receive transaction history information about user purchases in order to use the transaction history information for determining offers in which the user 4 may be interested. Therefore, in some embodiments of the invention the financial institution (or other business running the shopping systems 10) may partner with businesses in order to receive additional information regarding a breakdown of the actual purchases made by a user 4 at a business. For example, the financial institution may receive a digital receipt from the business that outlines the individual products purchased from the business by a user 4 associated with the financial institution. The digital receipt may include information such as, but not limited to SKUs, UPCs, or other product codes, descriptions of the products, the quantity of the products, the price of the products, the discounts applied to each product, or other product or purchase information, etc. The financial institution can then use the digital receipt information to improve the offers presented to the user 4 in order to increase product purchase rates.

Instead of partnering with the businesses, in some embodiments, the financial institution may be able to receive the transaction information directly from the users 4 themselves. For example, the user 4 can capture an image of the receipt and send it directly to the shopping systems 10, the user 4 can make the purchase using a mobile device (i.e. e-wallet, etc.) and an electronic receipt can be captured and sent to the shopping systems 10, the user 4 can manually enter in the transaction information, etc. The additional transaction information provides a more complete representation of the user's transaction history. The shopping systems 10 may use the transaction information to provide offers or optimize routes sent to the user 4 that are more in line with products in which the user 4 is actually interested. The financial institution may not have had access to this type of information in the past without a partnership with the businesses or cooperation from the user 4.

In some embodiments of the invention the offers or optimized routes received by a user 4, either through a shopping list or other means, may be passed on to other users 4 through social media or collective networks (i.e., a network of like customers with the same or similar interests). For example, a user receiving an offer may be able to pass the information about the offer to other user systems 20 in order to the share the potential offers with other users 4, and thus, the user 4 utilizing the shopping systems 10 may also be able to receive offers from other users 4 utilizing the shopping systems 10. In some embodiments, the businesses may prevent offers from being sent to other users 4. For example, the businesses may be able to sell a product to one user 4 for a specific price, but be able to sell the same product to another user 4 for another price. The business may only want send specialized offers to particular users 4 because the users 4 may be receiving the offers as rewards for being a loyal customer. Therefore, in some cases the offers, both discounted or not discounted, may be available universally to users 4 who utilize the shopping systems 10 or they may be limited to specific users 4. The offers may be sent or received automatically through the use of a set of user preferences, through manual input of a user 4 on a case-by-case basis, or through a combination of automatic and manual methods.

In some embodiments the offers may only be made to a group of users 4 and/or will only be valid if a group of users 4 take a specified action with respect to the offers. The offers may be based on total quantity or amount of one or more products sold, total quantity or amount spent on one or more products by one or more customers, the number of customers making a purchase, the type of customers making a purchase, etc. For example, a business may offer a discount on products from the grocery store, but only if the business sells five hundred (500) units of the products within a specified time period (i.e., week month, etc.).

In some embodiments of the invention offers may be provided to the user 4 not only on products in which the user is interested, such as through a shopping list identified by the user 4, but also based on related offers that could be associated with offers in which the user is interested. For example, in one embodiment of the invention the user 4 may be interested in pipe, wood, and particle board for a home improvement project. The shopping systems 10 and/or the business systems 30 may also provide the user 4 with drywall offers since the user 4 may also need drywall for the home improvement project.

In some embodiments of the invention the offers may be provided, through the shopping list or other method, utilizing a rule or preference based system that is automatically determined by the systems, or manually determined by a user 4 or business. In these embodiments a user 4 may set-up rules, or rules may automatically be applied by the shopping systems 10, to limit the offers received by the user 4 to only offers in which the user 4 is interested. The offers may be limited by to offers of a specific quantity, a specific price (i.e., set price, discount percentage, etc.), a specific product, a specific delivery date, etc. In these embodiments the offers are limited to only offers in which the user 4 is interested, instead of receiving offers for products that are not within the price range, quantity, delivery date, etc. that the user 4 wants. In other embodiments the business may set rules or rules may automatically be applied by the shopping system 10 to only offer products to a user 4 when the business can receive a specific price, a specific margin, a specific quantity sold, a specific delivery date, etc. for the products being offered by the business. In this way the business is only making offers that are in the best interest of the business. For example, the user 4 may indicate that the user 4 wants a product, but only if the product costs $100 or less. The business initially is only offering the product for $110 or more. Therefore, the offer would not be made. However, if the business needs to the clear inventory it may offer the product for $90. Therefore, it could offer the product to one customer for $100 and to another customer for $90. Alternatively, it could offer the product to all customers for $90, such that the customer who would buy the product for $100 would receive an additional $10 off the price at which the customer would have purchased the product. In this way the offers may be beneficial to the users 4 or the businesses depending on how the rules based system is set up.

In some embodiments of the invention the offers are provided in real time, provided when the offers meet the rules, provided on a daily or weekly basis, etc. Therefore, in some embodiments the systems is constantly determining offers, changing offers, etc. based on the products in which the users 4 are interested (i.e., based on the shopping lists, or other means of identifying the offers) and the offers that that are available from the businesses. In other embodiments the offers are not provided by the business until the user 4 submits the products in which the user 4 is interested (i.e., shopping list) to the shopping system 10 and/or businesses for review.

In some embodiments of the invention, the businesses may set the price of the offers based on publically available information regarding competitors prices based on public websites, databases, etc. In other embodiments, the user 4 may submit pricing information about competitors' prices in order to obtain the best deal. For example, in the case of a user 4 looking for home renovations a user may submit a first contractor's quote to a second contractor with the hope of starting a reverse auction in order to obtain the best price. In other examples, the user may provide a competitor home improvement store with pricing information from another home improvement store in order to try to get the competitor store to make a better offer to the user 4. Therefore, in some embodiments the shopping systems 10 may be an interactive system that allows users 4 to interface with businesses in order to secure the best available offers.

In some embodiments of the invention the user 4 may be automatically opted into the shopping system program to create shopping list and/or receive optimized routes for products in which the user 4 is interested. However, in other embodiments the user 4 has to opt-into the shopping system program. In some regards, the option to opt-in could be communicated to the customer when the customer is identified as within the geographic area of interest, the customer can preemptively opt-in such as via an online banking application or otherwise. In some embodiments, once the user has opted-in then the user receives the offers and/or optimized routes.

Various embodiments or features are presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
identifying products on a virtual shopping list of a user;
subjecting, through the use of a processing device, the virtual shopping list to a bid auction for two or more businesses;
identifying one or more offers for one or more products from the one or more businesses based on the virtual shopping list of the user;
making the one or more offers identified from the one or more businesses available to the user;
identifying a selection of the one or more offers from the user; and
making the selection of the one or more offers available to the one or more businesses.

2. The method of claim 1, further comprising:
receiving a request from the user to add products to a virtual shopping list.

3. The method of claim 2, wherein the products added to the virtual shopping list were captured by the user utilizing a data capture device that captures product identifiers.

4. The method of claim 1, wherein subjecting the virtual shopping list to a bid auction comprises transmitting the virtual shopping list to one or more businesses.

5. The method of claim 1, wherein subjecting the virtual shopping list to a bid auction comprises allowing the one or more businesses to access the virtual shopping list.

6. The method of claim 1, wherein the one or more offers are for all of the products on the virtual shopping list.

7. The method of claim 1, wherein the selection of the one or more offers are for all of the products on the virtual shopping list.

8. The method of claim 1, wherein the selection of the one or more offers is from one of the one or more businesses.

9. The method of claim 1, wherein the selection of the one or more offers is from two or more of the businesses.

10. The method of claim 1, further comprising identifying a discount from the one or more businesses associated with the one or more offers.

11. The method of claim 1, further comprising:
identifying a location associated with the user; and wherein the offers received for the one or more products from the one or more businesses are based on the location.

12. A system comprising:
a memory device having computer readable program code store thereon;
a communication device; and
a processing device operatively coupled to the memory device, and the communication device, wherein the processing device is configured to execute the computer readable program code to:
identify products on a virtual shopping list of a user;
submit the virtual shopping list to a bid auction for two or more businesses;
identify one or more offers for one or more products based on the virtual shopping list from the one or more businesses;
make the one or more offers identified from the one or more businesses available to the user;
identifiy a selection of the one or more offers from the user; and
make the selection of the one or more offers available to the one or more businesses.

13. The system of claim 12, wherein the processing device is further configured to execute the computer readable program code to receive a request from the user to add products to a virtual shopping list.

14. The system of claim 13, wherein the products added to the virtual shopping list were captured by the user utilizing a data capture device that captures product identifiers.

15. The system of claim 12, wherein the processing device configured to execute the computer readable program code to subject the virtual shopping list to a bid auction comprises transmitting the virtual shopping list to one or more businesses.

16. The system of claim 12, wherein the processing device configured to execute the computer readable program code to subject the virtual shopping list to a bid auction comprises allowing the one or more businesses to access the virtual shopping list.

17. The system of claim 12, wherein the one or more offers are for all of the products on the virtual shopping list.

18. The system of claim 12, wherein the selection of the one or more offers are for all of the products on the virtual shopping list.

19. The system of claim 12, wherein the selection of the one or more offers is from one of the one or more businesses.

20. The system of claim 12, wherein the selection of the one or more offers is from two or more of the businesses.

21. The system of claim 12, wherein the processing device is further configured to execute the computer readable program code to identify a discount from the one or more businesses associated with the one or more offers.

22. The system of claim 12, wherein the processing device is further configured to execute the computer readable program code to identify a location associated with the user; and wherein the offers received for the one or more products from the one or more businesses are based on the location.

23. A computer program product, the computer program product comprising at least one non-transitory computer-readable medium having computer-readable program code portions embodied therein, the computer-readable program code portions comprising:
an executable portion configured for identifying products on a virtual shopping list of a user;
an executable portion configured for submitting the virtual shopping list to a bid auction for two or more businesses;
an executable portion configured for identifying one or more offers for one or more products based on the virtual shopping list from the one or more businesses;
an executable portion configured for making the one or more offers identified from the one or more businesses available to the user;
an executable portion configured for identifiying a selection of the one or more offers from the user; and
an executable portion configured for making the selection of the one or more offers available to the one or more businesses.

24. The computer program product of claim 23, further comprising:
an executable portion configured for receiving a request from the user to add products to a virtual shopping list.

25. The computer program product of claim 24, wherein the products added to the virtual shopping list were captured by the user utilizing a data capture device that captures product identifiers.

26. The computer program product of claim 23, wherein the executable portion configured for subjecting the virtual shopping list to a bid auction comprises transmitting the virtual shopping list to one or more businesses.

27. The computer program product of claim 23, wherein the executable portion configured for subjecting the virtual shopping list to a bid auction comprises allowing the one or more businesses to access the virtual shopping list.

28. The computer program product of claim 23, wherein the one or more offers are for all of the products on the virtual shopping list.

29. The computer program product of claim 23, wherein the selection of the one or more offers are for all of the products on the virtual shopping list.

30. The computer program product of claim 23, wherein the selection of the one or more offers is from one of the one or more businesses.

31. The computer program product of claim 23, wherein the selection of the one or more offers is from two or more of the businesses.

32. The computer program product of claim 23, further comprising an executable portion configured for identifying a discount from the one or more businesses associated with the one or more offers.

33. The computer program product of claim 23, further comprising an executable portion configured for identifying a location associated with the user; and wherein the offers received for the one or more products from the one or more businesses are based on the location.
